(19) United States
(12) Patent Application Publication
(10) Pub. No.: US 2005/0218046 A1
(43) Pub. Date: Oct. 6, 2005

(54) System and method for sequencing mail in delivery point order

(75) Inventors: Daryl S. Mileaf, Hanover, MD (US); Stephanie A. Lauretano, Ellicott City, MD (US); Jason Park, Baltimore, MD (US); Patrick Cowgill, Cantonsville, MD (US); Stanley Wakamiya, Ellicott City, MD (US); Charles Shaw, Fairfax, VA (US)

Correspondence Address: ROTHWELL, FIGG, ERNST & MANBECK, P.C., 1425 K STREET, N.W., SUITE 800, WASHINGTON, DC, 20005, US

(73) Assignee: Northrop Grumman Corporation, Los Angeles, CA (US)

(21) Appl. No.: 10/771,342

(22) Filed: Feb. 5, 2004

Related U.S. Application Data
(60) Provisional application No. 60/523,113, filed on Nov. 19, 2003.

(51) Int. Cl. B07C 5/00; G06K 9/00

(52) U.S. Cl. 209/584

(57) ABSTRACT

A two-pass mail sorting method for sorting mail into delivery point order. In one embodiment, the method includes the step of forming a delivery point group comprising delivery points that are temporarily or permanently on hold. In another embodiment, the method includes the step of processing saturation mail only after performing the first-pass mail sort. In another embodiment, the method includes partitioning a mail sorting system comprising N outputs into X virtual mail sorting systems having N/X outputs.

This application claims the benefit of U.S. Provisional Patent Application No. 60/523,113 (attorney docket no. 2662-163), filed on Nov. 19, 2003, the contents of which are incorporated herein by this reference.

### BACKGROUND OF THE INVENTION

1. Field of the Invention

The present invention relates to systems and methods for sorting mail.

2. Discussion of the Background

The United States Postal Service (USPS) allows large volume mailers of flat mail to prepare a mailing in a number of formats and sequences. Flat mail typically is comprised of large envelopes, magazines and other periodical mail measuring typically no more than 15×12 inches, and typically no thicker than 1.25 inches.

Typically, flat mail (or “flats”) are prepared in bundles. Bundles are created to allow flats that are destined for the same carrier route or zone to be processed together.

There are a number of preparation schemes that mailers can use in preparing bundles of flats, and each scheme has a mailing cost associated with it. The following is an example of some of the various schemes in which mailers can prepare bundles of flats. The first example scheme is referred to as “3-digit.” In the 3-digit scheme, all mail within the bundle is addressed to a delivery point within a given 3-digit postal zone (this refers to the 1^{st} three digit of a zip code, i.e. 210xx). The mail within the bundle will be distributed to a number of facilities and carrier routes within that zone.

The second example scheme is referred to as “5-digit.” In the 5-digit scheme, all mail within the bundle is addressed to a 5-digit zone. The third example scheme is referred to as “carrier route”. In the carrier route scheme, the bundle contains only mail for a specific carrier within a given 5-digit zone. The last example scheme is referred to as “Line-of-Travel (LOT) and/or Carrier Sequenced (CS).” In the LOT/CS scheme, the bundles have been prepared such that the mail within the bundles is in a sequence for a specific carrier within a zone. LOT mail contains mail in either ascending or descending order for addresses on streets in a close approximation of how the carrier actually delivers the mail. Carrier Sequence mail is prepared in exactly the sequence that the carrier delivers the mail.

Each above scheme is processed by the USPS differently and has an associated processing cost. 3-digit mail is usually cross-docked through postal facilities as a bundle until it arrives at the processing center that serves the 3-digit zone. The bundle is then opened and processed to a 5-digit level and delivered to the post office that serves that 5-digit zone.

5-digit bundles are cross-docked all the way to the processing center that serves the 5-digit zone. Depending on the processing center operations, the bundle may be delivered to the local post office that delivers the mail or may be processed down to the carrier level (separating the mail to the carrier within the deliver office so that the carrier doesn't have to separate the mail). Carrier Route, LOT and Carrier sequence mail are all cross-docked directly to the local post office that delivers the mail.

In all cases, the local carrier “cases” the flats for his route to prepare them for delivery. That is, as carriers receive their flats for the day, they sort them into what is referred to as “delivery point order” or “carrier walk sequence”.

More specifically, casing a set of mail refers to the process of placing each piece of mail in the set into the appropriate cubbyhole in a matrix of cubbyholes. Each cubbyhole in the matrix corresponds to one delivery point on the carrier's route. Thus, by placing each piece of mail into its corresponding cubbyhole and then removing the mail from the cubbyholes in the order in which the carrier traverses his mail route, the carrier can create a bundle of mail that is in carrier walk sequence. Accordingly, the result of the casing operation is that all mail for each address or delivery point in the carrier's route is stacked together in order of delivery point. Thus, when the carrier arrives at a particular delivery point on his/her route, the carrier can simply remove from the “top” of his/her bundle of mail the mail addressed to the particular delivery point.

Because “casing” is a manual process, it can be time consuming and error prone. Therefore, it is desirable to eliminate this casing operation by providing to the carrier a bundle of all of the flats for the carrier's route in delivery point order.

### SUMMARY OF THE INVENTION

The present invention provides mail sorting systems and methods for sorting mail into delivery point order.

In one aspect, the present invention provides a two-pass mail sorting method for sorting mail into delivery point order. The method includes the steps of: (a) creating a first-pass sort plan, wherein the first-pass sort plan specifies: a first delivery point group comprising a first delivery point on a first carrier route and a first delivery point on a second carrier route, a second delivery point group comprising a second delivery point on the first carrier route and a second delivery point on the second carrier route, and a third delivery point group comprising delivery points on the first and second carrier routes that are on hold; feeding the batch of mail into a mail sorting system having a first, second and third output; and sorting the batch of mail according to the first-pass sort plan utilizing the first, second and third outputs, thereby forming (1) a first batch of mail comprising mail addressed to the first delivery point on the first carrier route and the first delivery point on the second carrier route; (2) a second batch of mail comprising mail addressed to the second delivery point on the first carrier route and the second delivery point on the second carrier route; and (3) a third batch of mail comprising mail addressed to the delivery points that are on hold. By creating a batch of mail comprising mail addressed to the delivery points that are on hold, the present invention separates mail that is on hold from the other mail. Advantageously, since the mail is on hold, it need not be sorted according to the second-pass sort plan. Accordingly, a throughput increase is achieved by this embodiment of the present invention.

In another aspect, the present invention provides a two-pass mail sorting method for sorting mail into delivery point order, which method includes the step of partitioning a mail sorting system into at least two “virtual” mail sorting systems by creating a first-pass sort plan, wherein the first-pass sort plan specifies: a first delivery point group comprising a first delivery point on a first carrier route and a first delivery point on a second carrier route, a second delivery point group comprising a second delivery point on the first carrier route and a second delivery point on the second carrier route, a third delivery point group comprising a first delivery point on a third carrier route and a first delivery point on a fourth carrier route, a fourth delivery point group comprising a second delivery point on the third carrier route and a second delivery point on the fourth carrier route. By partitioning the mail sorting system in this manner, efficiencies can be achieved.

The above and other features and advantages of the present invention, as well as the structure and operation of preferred embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 is a functional block diagram of an example flats sorting system.

FIG. 2 is a flow chart illustrating a process according to an embodiment of the invention.

FIG. 3 is a table illustrating a first-pass sort plan according to an embodiment of the invention.

FIG. 4 is a table illustrating a second-pass sort plan according to an embodiment of the invention.

FIGS. 5A-C illustrate the delivery order sequencing of mail.

FIG. 6 is a flow chart illustrating a process according to another embodiment of the invention.

FIG. 7 is a table illustrating a first-pass sort plan according to another embodiment of the invention.

FIG. 8 is a table illustrating a second-pass sort plan according to another embodiment of the invention.

FIGS. 9A-C illustrate the delivery order sequencing of mail.

### DETAILED DESCRIPTION OF THE PREFERRED EMBODMENT

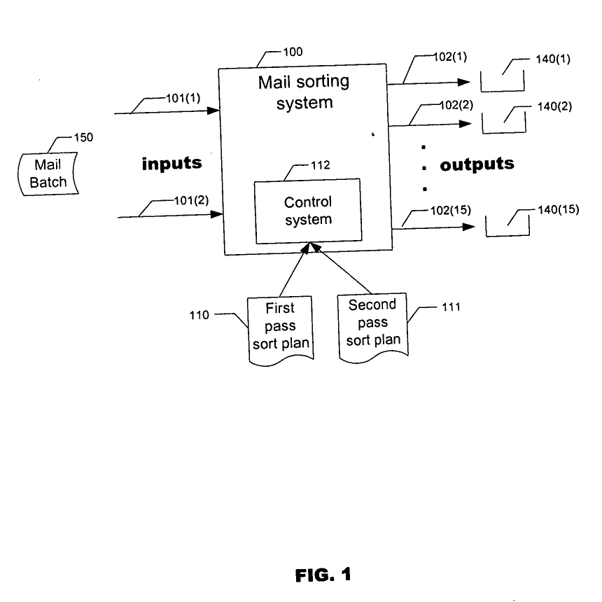

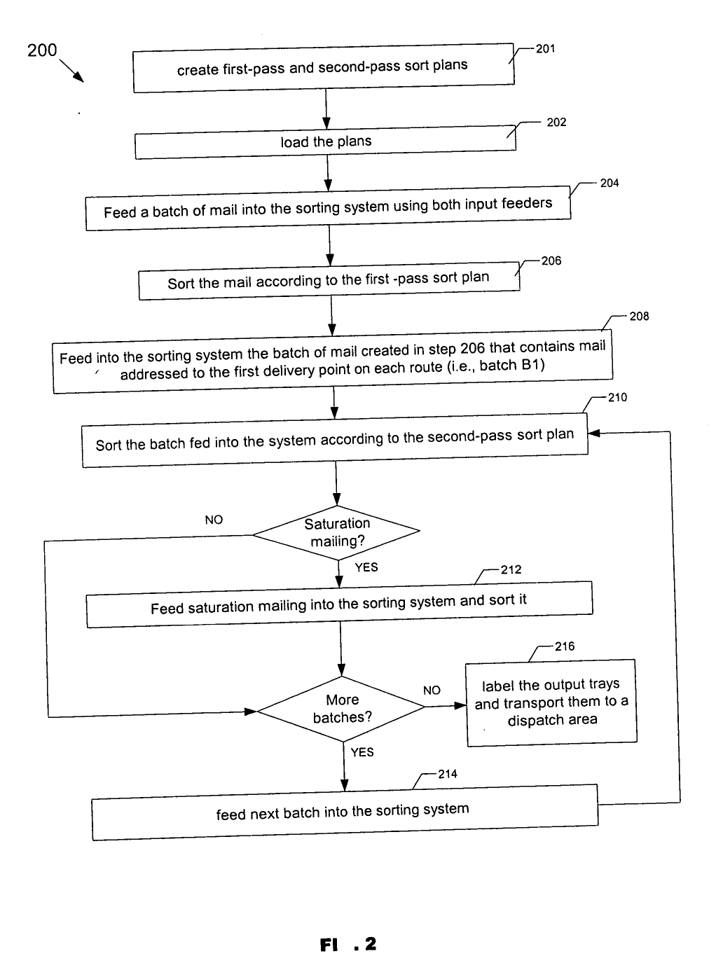

For the sake of illustration and clarity, embodiments of the present invention will described with respect to a mail sorting system 100 (see FIG. 1) having two input feeders 101(1), 101(2) and fifteen outputs 102(1)-102(15). However, the invention is not limited to this configuration or to any particular mail sorting system or machine. The invention may be able to work with a sorting system having M input feeders (M>0) and N outputs (N>1). For example, it is contemplated that one embodiment has 4 input feeders and at least 360 outputs. Any conventional mail sorting system can be used.

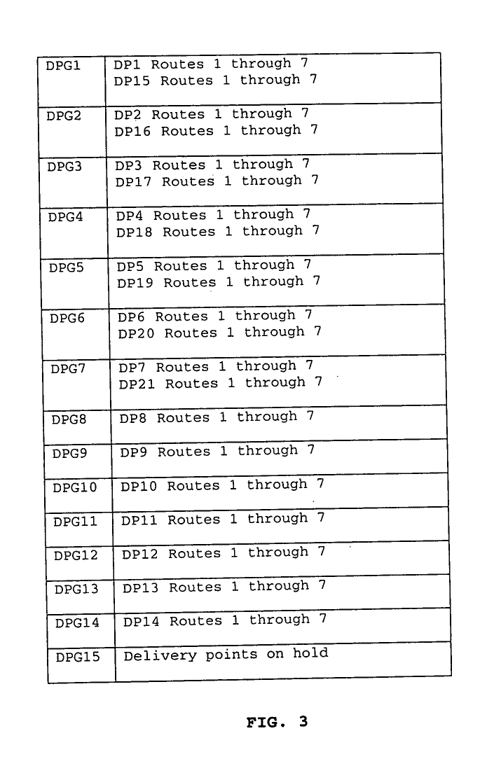

With a mail sorting system having 15 outputs and with the maximum number of delivery points on any mail route being 21 or less, it is possible to sort mail into delivery point order for seven (7) different carrier routes simultaneously using a two-pass sorting method 200 (see FIG. 2) according to an embodiment of the present invention.

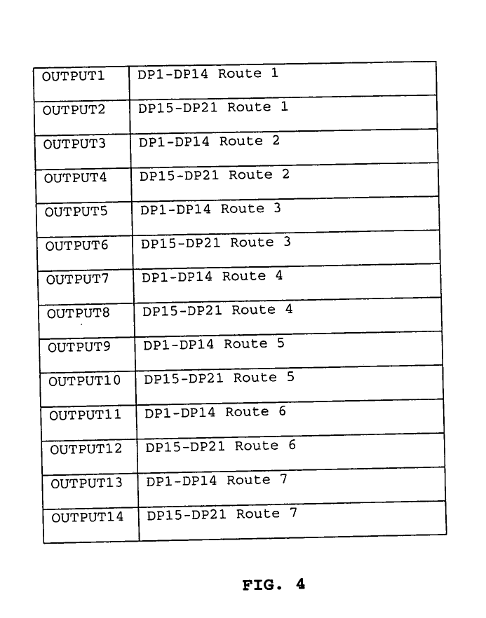

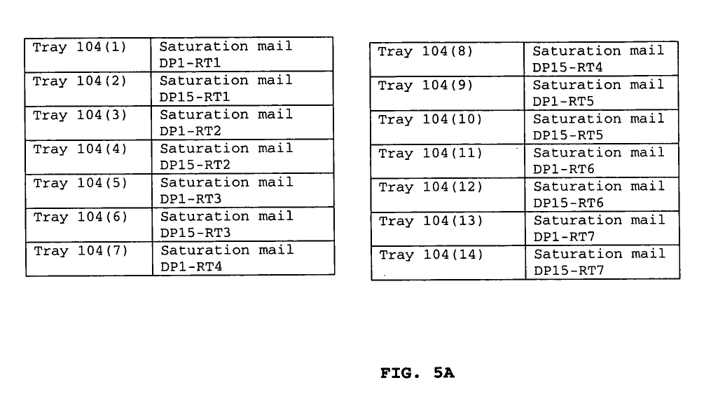

The two pass sorting method 200 begins in step 201, where a first-pass sort plan 110 and a second-pass sort plan 111 are created. For the first pass of the mail through system 100, first-pass sort plan 110 specifies fourteen (14) “delivery point groups.” A delivery point group, as its name implies, is a group of delivery points. FIG. 3 illustrates the fourteen delivery point groups specified by first-pass sort plan 110. Mathematically, the set of delivery points (“DPs”) included in delivery point group J, where J is <=14, is DPk-RTi (RTi stands for the ith carrier route), where: i=1,2,3,4,5,6,7; k=(0)N+J,(1)N+J, . . . , (M)N+J; N the number of delivery point groups (in this case N=14); M=[ceiling(MAX/N)−1]; and MAX is the maximum number of delivery points per carrier route, which in this case is 21. Accordingly, delivery point group 2 (“DPG2”), for example, includes the following DPs: DP2-RTi and DP16-RTi, i=1,2,3,4,5,6,7.

Advantageously, sort plan 110 also specifies a fifteenth delivery point group (DPG15). In one embodiment, the DPG15 specifies, among other things, a set of delivery points to which mail should not be delivered. For example, if the persons living at delivery point 7 (DP7) on mail route (RT1) are on vacation and they told their local post office to hold their mail while they are away, then DPG15 would include delivery point DP7-RT1 as well as other delivery points to which mail should temporarily (or permanently) not be delivered.

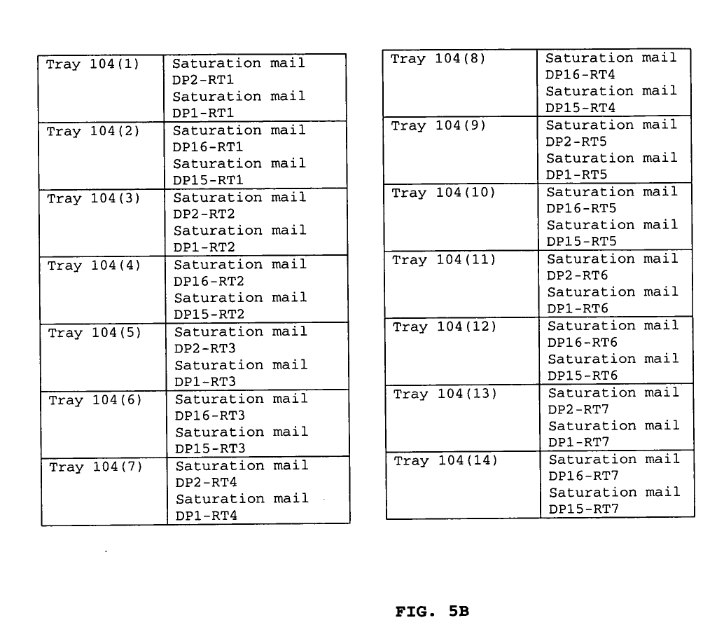

For the second pass, second-pass sort plan 111 assigns to 14 of the 15 outputs a set of delivery points on a route. This is illustrated in FIG. 4. For example, as shown in FIG. 4, DP1 through DP14 on route 1 are assigned to output 1 and DP15 through DP21 on route 1 are assigned to output 2. Similarly, DP1-DP14 and DP15-DP21 on route 2 are assigned to outputs 3 and 4, respectively; DPl-DP14 and DP15-DP21 on route 3 are assigned to outputs 5 and 6, respectively, etc . . . .

In step 202, sort plans 110, 111 are loaded into a control system 112 of flats sorting system 100. In step 204, a batch of mail 150 is fed into system 100 using both input feeders 101(1) and 101(2). Preferably, each piece of mail in the batch is addressed to a delivery point on one of the seven carrier routes.

In step 206, controller 112 controls system 100 so that it sorts the batch of mail 150 according to first-pass sort plan 110. That is, system 100 will sort the batch of mail 150 into 15 smaller batches according to sort plan 110.

Accordingly, one of the 15 smaller batches (which we will refer to as “batch-15” or simply “B15”) includes all the mail that should not be delivered (e.g., the mail that is temporarily or permanently on hold). Accordingly, system 100, after receiving a piece of mail, checks to see if the piece of mail is addressed to a delivery point that is included in DPG-15 and, if it is, it adds the piece mail of mail to Batch-15. That is, the piece of mail is added to Batch-15 if it is addressed to a delivery point to which mail should not be delivered.

Each of the other fourteen batches of mail (B1 through B14) created by system 100 and sort plan 110 corresponds to a different one of the delivery point groups (DPGs). For the sake of clarity, we will express this as: Batch-N<=>DPGN, which signifies that Batch-N corresponds to the Nth delivery point group. Because Batch-N (“BN”) corresponds to DBPGN, all of the mail that is included in BN is addressed to a delivery point that is in DPGN. As a concrete example, every piece of mail that is in B1 is addressed to a delivery point that is in DPG1. Referring to FIG. 3, the delivery points that are included in DPG1 are: DP1-RTi and DP15-RTi, where i=1,2,3,4,5,6,7; that is the first and fifteenth delivery points for each of routes 1-7.

In one embodiment, system 100 creates the batches B1-B14 by assigning each delivery point on each of the seven routes to one of its fourteen outputs according to the delivery point group to which the delivery point belongs. System 100 does this by assigning each delivery point group to a different one of its fourteen outputs (e.g., DPG1 is assigned to output 102(1); DPG2 is assigned to output 102(2), and DPG14 is assigned to output 102(14)). In this way, after system 100 receives a flat and determines the delivery point to which the flat is addressed, system 100 can automatically route the flat to the output 102 to which the delivery point is assigned. As a concrete example, assume that system 100 determined that a particular flat is addressed to delivery point DP16-RT3 (the sixteenth delivery point on route 3); in this case the flat will be routed to output 102(2) because DP16-RT3 is a member of DPG2 and DPG2 is assigned to output 102(2).

When sorting batch 150 there may be times when an output tray 140 becomes “full.” When an output tray 140 is full no mail should be sent to the output 102 associated with the output tray 140. Consequently, in one embodiment, when system 100 has determined the output to which a particular piece of mail should be routed and has determined that the output tray associated with that output is full, system 100 will buffer or otherwise hold the particular piece of mail until the output tray is no longer full (e.g., the tray at that output has been replaced with a new, empty tray).

Holding mail in the above described manner is not preferable because doing so adversely affects the throughput of system 100. Accordingly, in another embodiment, controller 112 may be configured to dynamically re-assign a delivery point group to an output not currently being utilized when system 100 is ready to route a piece of mail that is addressed to a delivery point in the delivery point group and the system determines that the output to which the delivery point group is assigned is full or otherwise not functioning. Accordingly, the throughput of the system is not adversely affected when an output becomes full, provided that there is an available output to which the delivery point group can be re-assigned.

In step 208, batch B1 is fed into system 100 using one or both input feeders 101. In step 210, controller 112 controls system 100 so that it sorts the batch of mail according to second-pass sort plan 111. That is, system 100 (1) receives a piece of mail from the batch, (2) analyzes the piece of mail to determine the delivery point to which the piece of mail is addressed and then (3) routes the piece of mail to the output to which the delivery point is assigned. As a specific example, lets assume that system 100 received a piece of mail addressed to delivery point DP15-RT5 (i.e., the fifteenth delivery point on route 5); in this case the piece of mail is routed to output 10 because, as shown in FIG. 4, DP15-RT5 is assigned to output 10. Preferably, one or more trays 140 are positioned at each output to collect the mail routed to the output.

If a saturation mailing exists for any one of the seven routes, then step 212 is performed, otherwise the process proceeds to step 214. A saturation mailing for a route is a mailing that covers at least 75% of all delivery points on the route or 90% of the residential delivery points on the route. For example, a local store may wish to send an advertisement to every residential delivery point on one or more routes.

In step 212, at most two pieces of the saturation mailing for each route for which the saturation mailing is intended is fed into system 100, which routes each piece of saturation mail to the appropriate output (the reason that it is at most two pieces per route is because, in our example, each route is associated with at most 2 outputs 102, as shown in FIG. 4). Accordingly, if the saturation mailing is intended for delivery points on three of the seven routes, then at most 6 pieces of the mailing are fed into system 100, which routes the at most 6 pieces of mail to the appropriate output. For example, if a saturation mailing is intended for all delivery points on routes RT1, RT3 and RT5, then six (6) pieces of the saturation mailing are fed into the system 100 at step 212 and each of the 6 saturation mail pieces will be routed to an output associated with RT1, RT3 or RT5. More specifically, in this example, one saturation mail piece is routed to output 1, which is associated with RT1, another to output 2, which is also associated with RT1, another to output 5, which is associated with RT3, another to output 6, which is also associated with RT3, another to output 9, which is associated with RT5, and the last to output 10, which is also associated with RT5. Step 212 may be repeated if there is more than one saturation mailing for at least one of the seven routes.

In step 214, the next batch in the sequence is fed into system 100 (if there is not a next batch, then the process proceeds to step 216). For example, if batch-X was the last batch processed, then Batch-(X+1) is the next batch to process since it is the next batch in the sequence. In our example, batch B14 is the last batch because batch B15 does not need to be further sorted at this time. After step 214, control passes back to step 210.

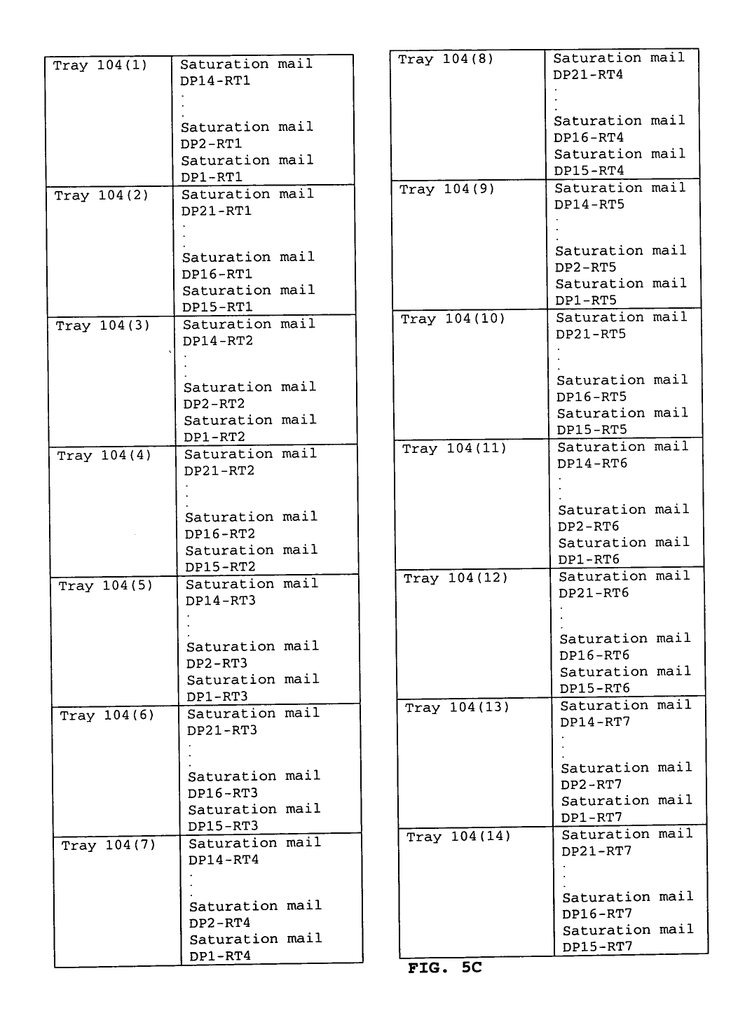

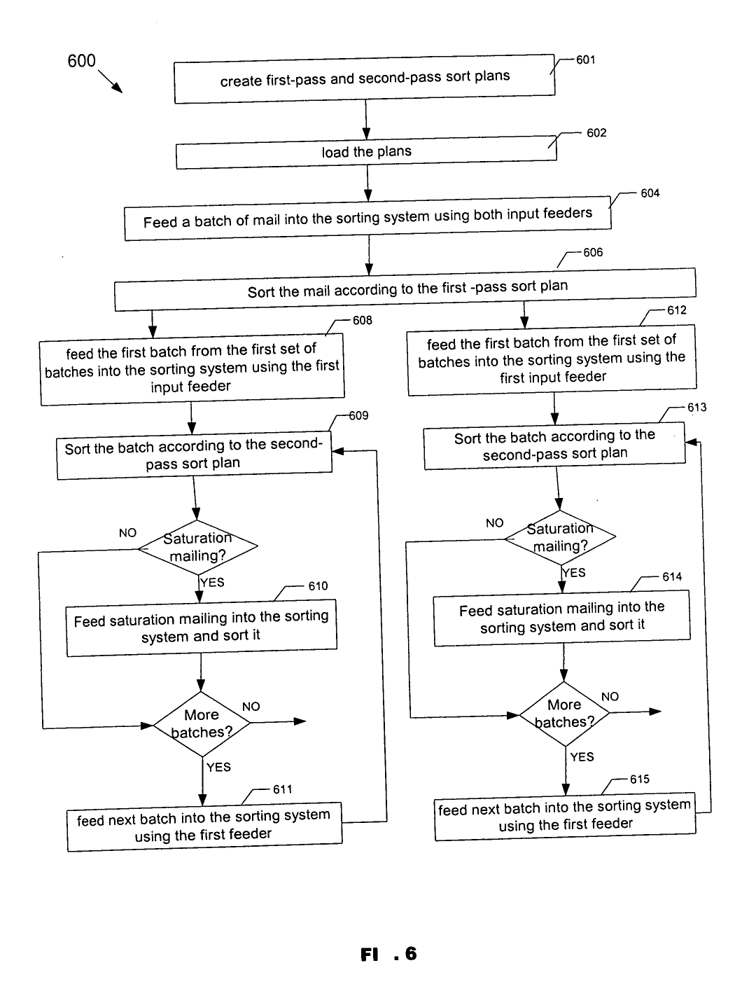

FIGS. 5A-C illustrate the contents of the fourteen trays 140(1)-(14), where each tray 140(X) is positioned to receive the mail routed to output 102(X), after batches B1, B2, and B14 have been processed by system 100 in step 210 and after the saturation mailing, if any, was processed in step 212, respectively.

As shown in FIG. 5A, after batch B1 and saturation mailings, if any, are processed (i.e., the first time steps 210-212 are preformed), tray 140(1) includes all mail addressed to delivery point DP1-RT1 and zero or more saturation mail pieces, tray 140(2) includes all mail addressed to delivery point DP15-RT1 and zero or more saturation mail pieces, tray 140(3) includes all mail addressed to delivery point DP1-RT2 and zero or more saturation mail pieces, tray 140(4) includes all mail addressed to delivery point DP15-RT2 and zero or more saturation mail pieces, . . . , and tray 140(14) include all mail addressed to delivery point DP15-RT7 and zero or more saturation mail pieces.

As shown in FIG. 5B, the second time steps 210-212 are preformed, tray 140(1) further includes all mail addressed to delivery point DP2-RT1 and zero or more additional saturation mail pieces, tray 140(2) further includes all mail addressed to delivery point DP16-RT1 and zero or more additional saturation mail pieces, tray 140(3) further includes all mail addressed to delivery point DP2-RT2 and zero or more additional saturation mail pieces, tray 140(4) further includes all mail addressed to delivery point DP16-RT2 and zero or more additional saturation mail pieces, and tray 140(14) further includes all mail addressed to delivery point DP16-RT7 and zero or more additional saturation mail pieces.

Finally, as shown in FIG. 5C, after the final time steps 210-212 are preformed, tray 140(1) includes all mail addressed to delivery points DP1-RT1 through DP14-RT1 and zero or more saturation mail pieces positioned atop each delivery point; tray 140(2) includes all mail addressed to delivery points DP15-RT1 through DP21-RT1 and zero or more saturation mail pieces; tray 140(3) includes all mail addressed to delivery points DP1-RT2 through DP14-RT2 and zero or more saturation mail pieces; tray 140(4) includes all mail addressed to delivery points DP15-RT2 through DP21-RT2 and zero or more saturation mail pieces; . . . ; tray 140(14) includes all mail addressed to delivery points DP15-RT7 through DP21-RT7 and zero or more saturation mail pieces.

It should be noted that if a delivery point on RT1 had a temporary hold on their mail, then the output tray would not include mail addressed to that delivery point because, as discussed above, that mail would have been diverted to batch 15, which, unlike batches 1-14, was not fed into and processed by system 100 during the performance of process 200.

In short, FIGS. 5A-D illustrate that the two-pass mail sorting process 200 described above sorts mail for a number of routes into delivery point order. This greatly facilitates the mail carrier's job because it relieves the mail carrier from having to manually put the mail in delivery point order. Additionally, FIGS. 5A-D illustrate that by processing the saturation mailings after processing a batch of regular mail, the saturation mailing can be used as a divider between delivery points. This will help the mail carrier identify where one set of mail for one delivery point ends and another set of mail for the next delivery point begins.

In step 216 (i.e., the end of Pass 2), the output trays 140 are labeled and transported to a dispatch area where the are staged and prepared for transportation to the appropriate delivery unit while a residual pass (if required) is being performed.

Residual mail is an inevitable by-product of automated mail processing. Residual mail includes as a minimum: first pass holdouts of mail (i.e., in our example, this is the mail addressed to a delivery point included in DPG15); out of scheme rejects from the first pass; out of scheme rejects from the second pass; and mail whose addresses could not be determined.

Holdouts for a particular zone can be grouped together using a minimum number of output bins on the pass 1 sort plan. This mail can be efficiently sorted to carrier route or Box Section on a residual mail pass. It is mail that has received only one pass, so the Pass 2 for this mail is the residual mail pass.

Out of scheme rejects from the second pass also can be sorted to carrier route on the residual mail pass. Further, there may be merit in reprocessing the expected small amount of OCR/BCR/VCS reject mail on that pass, for the usual gain in read rate on a second try. Essentially, in this scenario the only residual mail that will not be sorted to carrier route is the out of scheme rejects from Pass 1, which should be sent to other operations for redirecting at the end of pass 1, and the final OCR/BCR/VCS rejects.

Residual mail processing may be performed immediately after the second pass is completed, so that the residual mail for each carrier can be transported with that route's sequenced mail, but this is not a requirement. Since most of the residual mail will have received only one pass, the total piece handlings and processing time will be approximately the same as if that mail had been sequenced through the full two-pass operation. The reduction of in-office labor required to manually sort this mail to carrier route and prepare it for delivery is expected to more than offset the set up labor and the flow time for the residual pass.

As described above, during the second-pass, a batch of first-pass sorted mail may be fed into system 100 using one or both of the input lines 102. If only one of the input lines 102 is used, then system 100 is not operating at its peak efficiency since one input line is idle. However, it may be complex or difficult to utilize both input lines 102 simultaneously to process a batch of first-pass, sorted mail. This is because the trays that hold the batch of mail would need to be distributed to multiple feeders in a balanced fashion. Additionally, the controls and safeguards that would be required to inhibit the feeding of mail prematurely or out of sequence, the problems that would occur if one feeder had a jam, etc., make this an unattractive option.

One way to overcome this problem is to partition system 100 into two or more “virtual systems” by reconfiguring the first-pass sort plan 110 so that instead of creating one set of N delivery point groups for all of the routes, the sort plan creates X sets of N/X delivery points groups, wherein each set of delivery point groups is associated with a different set of routes. The drawback of this approach, however, is that it can't process as many routes simultaneously. Nevertheless, the increase in system efficiency may offset this drawback.

For the sake of clarity, we will describe the “virtual machine” embodiment with respect to flat sorting system 100 being partitioned into two virtual machines, one of which is used to sort mail for route1 and route2, and the other of which is used to sort mail for route3 and route4. However, one skilled in the art will recognize that system 100 may be portioned into more than two virtual machines.

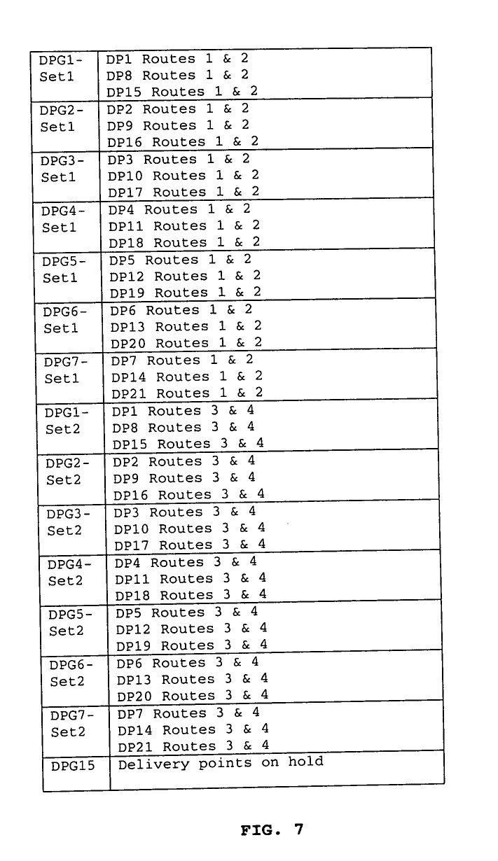

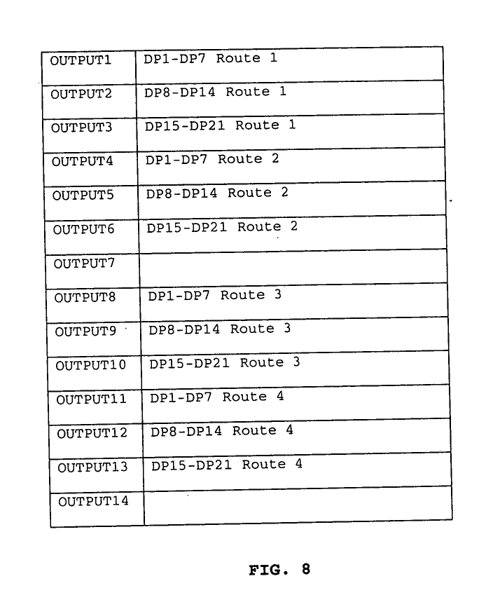

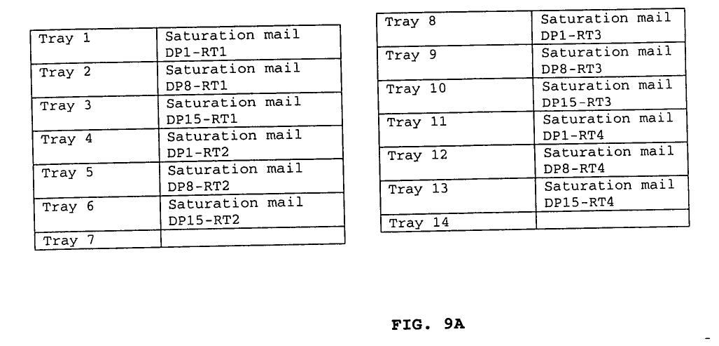

FIG. 6 is a flow chart illustrating a two-pass sorting method 600 that is used when system 100 is partitioned into two virtual machines. Process 600 begins in step 601, where a first-pass and second-pass sort plan is created. For the first pass of the mail through system 100, the first-pass sort plan specifies two sets of seven (7) delivery point groups for a total of fourteen delivery point groups. FIG. 7 illustrates the two sets of seven delivery point groups specified by the first-pass sort plan.

The set of delivery points (“DPs”) included in delivery point group J (0<J<=7) of the first set of delivery point groups is: DPk-RTi, where i=1,2; k=(0)N+J,(1)N+J, . . . , (M)N+J; N is the number of groups in the set (in this case N=7); and M=[ceiling(MAX/N)−1], where MAX is the maximum number of delivery points per carrier route, which in this case is 21. Thus, for example, delivery point group 2 in the first set of DPGs (i.e., “Set1-DPG2”) includes the following DPs: DP2-RT1, DP9-RT1, DP16-RT1, DP2-RT2, DP9-RT2, and DP16-RT2.

Similarly, the set of delivery points included in delivery point group J (0<J<=7) of the second set of delivery point groups is: DPk-RTj, where j=3,4. Thus, for example, delivery point group 2 in the second set of DPGs (i.e., “Set2-DPG2”) includes the following DPs: DP2-RT3, DP9-RT3, DP16-RT3, DP2-RT4, DP9-RT4, and DP16-RT4.

As is illustrated, each delivery point within any one of the DPGs within the first set of DPGs is either on the first route or the second route, and each delivery point within any one of the DPGs within the second set of DPGs is either on the third route or the fourth route. That is the first set of DPGs 710 is associated with routes 1 and 2, and the second set of DPGs 720 is associated with routes 3 and 4.

Advantageously, the sort plan may also specify a fifteenth delivery point group (DPG15). As described above, DPG15 may specify, among other things, a set of delivery points to which mail should not be delivered.

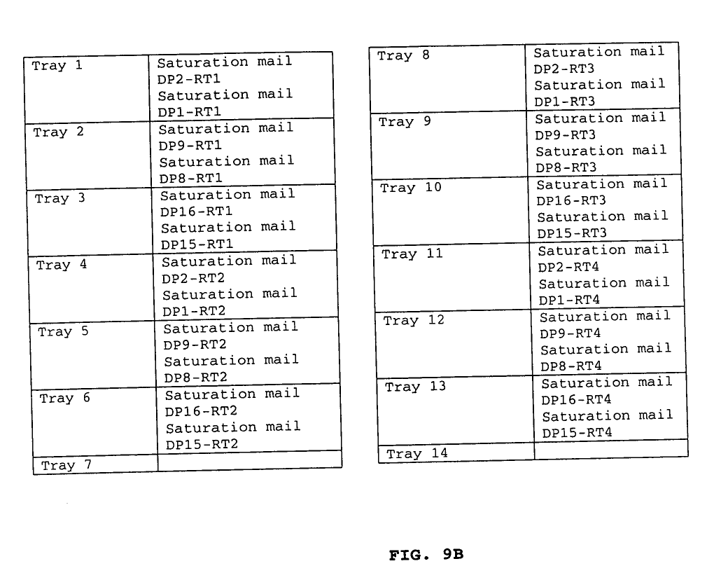

For the second pass, the second-pass sort plan 111 assigns to 12 of the 15 outputs a set of delivery points for a given route. This is illustrated in FIG. 8. For example, as shown in FIG. 8, DP1-DP7, DP8-DP14, and DP15-DP21 on route 1 are assigned to outputs 1, 2 and 3, respectively; DPl-DP7, DP8-DP14, and DP15-DP21 on route 2 are assigned to outputs 4, 5 and 6, respectively; DP1-DP7, DP8-DP14, and DP15-DP21 on route 3 are assigned to outputs 8, 9 and 10, respectively; and DP1-DP7, DP8-DP14, and DP15-DP21 on route 4 are assigned to outputs 11, 12 and 13, respectively.

In step 602, the first-pass and second-pass sort plans are loaded into the control system 112. In step 604, batch of mail 150 is fed into system 100 using both input feeders 101(1) and 101(2). Preferably, each piece of mail in the batch is addressed to a delivery point on one of the four routes 1-4.

In step 606, controller 112 controls system 100 so that it sorts the batch of mail 150 according to the first-pass sort plan. That is, system 100 will sort the batch of mail 150 into 15 smaller batches according to the first-pass sort plan. More specifically, batch of mail 150 is sorted into a first set of seven batches of mail—corresponding to the first set of DPGs, a second group of seven batches of mail—corresponding to the second set of DPGs, and a 15th batch of mail, which includes all the mail addressed to a delivery point that was assigned to DPG15.

Each one of the seven batches of mail from the first set corresponds to a different one of the DPGs within the first set of DPGs. For the sake of clarity, we will assume that batch N (0<N<=7) from the first set of batches (“BN-Set1”) corresponds to the Nth delivery point group (DPGN) from the first set of DPGs (“DPGN-Set1”). Because BN-Set1 corresponds to DBPGN-Set1, all of the mail that is included in BN-Set1 is addressed to a delivery point that is in DPGN-Set1. As a concrete example, every piece of mail that is in B1-Set1 is addressed to a delivery point that is in DPG1-Set1. Referring to FIG. 7, the delivery points that are included in DPG1-Set1 are: DP1-RT1, DP8-RT1, DP15-RT1, DP1-RT2, DP8-RT2, and DP15-RT2.

Similarly, each one of the seven batches of mail from the second set corresponds to a different one of the DPGs within the second set of DPGs. For the sake of clarity, we will assume that batch N (0<N<=7) from the second set of batches (“BN-Set2”) corresponds to the Nth delivery point group (DPGN) from the second set of DPGs (“DPGN-Set2”). Because BN-Set2 corresponds to DBPGN-Set2, all of the mail that is included in BN-Set2 is addressed to a delivery point that is in DPGN-Set2. As a concrete example, every piece of mail that is in B1-Set2 is addressed to a delivery point that is in DPG1-Set2. Referring to FIG. 7, the delivery points that are included in DPG1-Set1 are: DP1-RT3, DP8-RT3, DP15-RT3, DPl-RT4, DP8-RT4, and DP15-RT4.

In one embodiment, system 100 creates the batches B1-Set1, B1-Set2, B2-Set1, B2-Set2, etc . . . by assigning each delivery point on each of the four routes to one of the fourteen outputs according to the delivery point group to which the delivery point belongs in the same manner as discussed above with respect to process 200. After step 606, process 600 may proceed to steps 608 and 612 in parallel.

In step 608, batch B1-Set1 is fed into system 100 using feeder 101(1). In step 609, system 100 sorts the batch of mail input into feeder 101(1) according to the second-pass sort plan. If a saturation mailing exists for route 1 or 2, then the process proceed from step 609 to step 610, otherwise the process proceeds from step 609 to step 611.

In step 610, three pieces of the saturation mailing for each route in the first set of routes (i.e., route1 and route2) for which the saturation mailing is intended is fed into system 100, which routes each piece of saturation mail to the appropriate output (the reason that three pieces are per route are fed into system 100 is because, in our example, each route is associated with at most 3 outputs 102, as shown in FIG. 8). Accordingly, if the saturation mailing is intended for both routel and route2, then 6 pieces of the mailing are fed into system 100, which routes each of the 6 pieces of mail to the appropriate output. Step 610 may be repeated if there is more than one saturation mailing for at least one of the two routes.

In step 611, the next batch in the sequence from the first set of batches is fed into system 100 (if there is not a next batch, then the process may end). For example, if BX-Set1 was the last batch processed, then B(X+1)-Set1 is the next batch to process since it is the next batch in the sequence. After step 611, control passes back to step 609.

In step 612, batch B1-Set2 is fed into system 100 using feeder 101(2). In step 613, system 100 sorts the batch of mail input into feeder 101(2) according to the second-pass sort plan. If a saturation mailing exists for route 3 or 4, then the process proceed from step 613 to step 614, otherwise the process proceeds from step 613 to step 615.

In step 614, at most three pieces of the saturation mailing for each route in the second set of routes (i.e., route3 and route4) for which the saturation mailing is intended is fed into system 100, which routes each piece of saturation mail to the appropriate output. Step 614 may be repeated if there is more than one saturation mailing for at least one of the two routes.

In step 615, the next batch in the sequence from the second set of batches is fed into system 100 (if there is not a next batch, then the process may end). For example, if BX-Set2 was the last batch processed, then B(X+1)-Set2 is the next batch to process since it is the next batch in the sequence. After step 615, control passes back to step 613.

Preferably, steps 608-A11 are performed in parallel with steps 612-A15, as indicated in the flow chart shown in FIG. A. By performing these steps in parallel, the through put of the system is greatly increased.

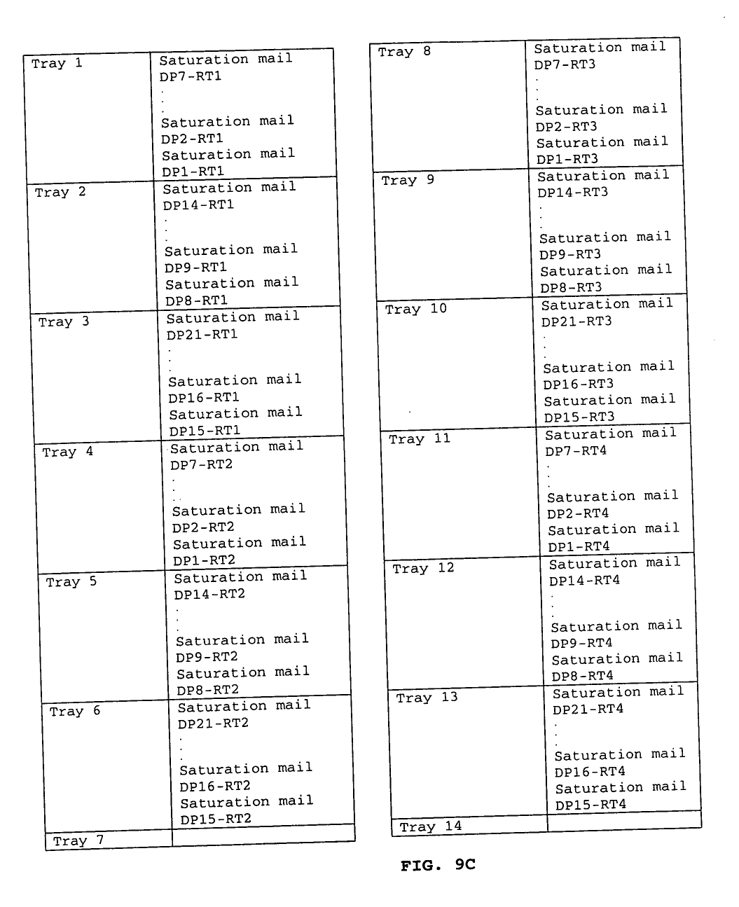

FIGS. 9A-C illustrate the contents of the fourteen trays 140(1)-(14), where each tray 140(X) is positioned to receive the mail routed to output 102(X), after batches B1-Sets1&2, B2-Sets1&2, and B7-Sets1&2 have been sorted. As shown in FIG. 9A, after batches B1-Sets1&2 and saturation mailings, if any, are processed (i.e., the first time steps 210-212 are preformed.), tray 140(1) includes all mail addressed to delivery point DP1-RT1 and zero or more saturation mail pieces, tray 140(2) includes all mail addressed to delivery point DP8-RT1 and zero or more saturation mail pieces, tray 140(3) includes all mail addressed to delivery point DP15-RT1 and zero or more saturation mail pieces, tray 140(4) includes all mail addressed to delivery point DP1-RT2 and zero or more saturation mail pieces, . . . , and tray 140(13) include all mail addressed to delivery point DP15-RT4 and zero or more saturation mail pieces.

As shown in FIG. 9B, after batches B2-Sets1&2 and saturation mailings, if any, are sorted, tray 140(1) further includes all mail addressed to delivery point DP2-RT1 and zero or more additional saturation mail pieces, tray 140(2) further includes all mail addressed to delivery point DP9-RT1 and zero or more additional saturation mail pieces, tray 140(3) further includes all mail addressed to delivery point DP16-RT1 and zero or more additional saturation mail pieces, tray 140(4) further includes all mail addressed to delivery point DP2-RT2 and zero or more additional saturation mail pieces, . . . , and tray 140(13) further includes all mail addressed to delivery point DP16-RT4 and zero or more additional saturation mail pieces.

Finally, as shown in FIG. 9C, after batches B7-Sets1&2 and saturation mailings, if any, are sorted, tray 140(1) includes all mail addressed to delivery points DP1-RT1 through DP7-RT1 and zero or more saturation mail pieces positioned atop (or underneath) each delivery point; tray 140(2) includes all mail addressed to delivery points DP8-RT1 through DP14-RT1 and zero or more saturation mail pieces; tray 140(3) includes all mail addressed to delivery points DP15-RT1 through DP21-RT1 and zero or more saturation mail pieces; tray 140(4) includes all mail addressed to delivery points DP1-RT2 through DP7-RT2 and zero or more saturation mail pieces; . . . ; and tray 140(13) includes all mail addressed to delivery points DP15-RT4 through DP21-RT4 and zero or more saturation mail pieces. As shown in FIG. 9C, the present invention sorts four routes of mail simultaneously into delivery point order.

While the processes described herein have been illustrated as a series or sequence of steps, the steps need not necessarily be performed in the order described, unless indicated otherwise.

Further, while various embodiments/variations of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A method for sorting a batch of mail into delivery point order using a mail sorting system comprising a first output, a second output, and a third output, comprising:
creating a first-pass sort plan, wherein the first-pass sort plan specifies: a first delivery point group comprising a first delivery point on a first carrier route and a first delivery point on a second carrier route, a second delivery point group comprising a second delivery point on the first carrier route and a second delivery point on the second carrier route, and a third delivery point group comprising delivery points on the first and second carrier routes that are on hold;
creating a second-pass sort plan, wherein the second-pass sort plan assigns the first and second delivery points on the first carrier route to the first output and assigns the first and second delivery points on the second carrier route to the second output;
feeding the batch of mail into the mail sorting system;
sorting the batch of mail according to the first-pass sort plan utilizing the first, second and third outputs, thereby forming (1) a first batch of mail comprising mail addressed to the first delivery point on the first carrier route and the first delivery point on the second carrier route; (2) a second batch of mail comprising mail addressed to the second delivery point on the first carrier route and the second delivery point on the second carrier route; and (3) a third batch of mail comprising mail addressed to a delivery point that is on hold;
feeding the first batch of mail into the mail sorting system;
sorting the first batch of mail according to the second-pass sort plan; and
feeding one or more pieces of saturation mail into the mail sorting machine after sorting the first batch of mail.

2. The method of claim 1, further comprising:
feeding the second batch of mail into the mail sorting system after feeding the one or more pieces of saturation mail into the mail sorting machine; and
sorting the second batch of mail according to the second-pass sort plan.

3. The method of claim 1, further comprising the step of assigning the first delivery point group to the first output prior to sorting the batch of mail according to the first-pass sort plan.

4. The method of claim 1, wherein the step of feeding the batch of mail into the mail sorting system includes the step of feeding some of the mail from the batch into the system using a first input feeder and feeding some of the mail from the batch into the system using a second input feeder.

5. The method of claim 1, wherein the step of feeding the first batch of mail into the mail sorting system includes the step of feeding some of the mail from the first batch into the system using a first input feeder and feeding some of the mail from the batch into the system using a second input feeder.

6. The method of claim 1, wherein the step of feeding the first batch of mail into the mail sorting system includes the step of feeding all of the mail from the first batch into the system using a first input feeder.

7. The method of claim 1, wherein the third batch of mail, which comprises mail addressed to a delivery point that is on hold, is processed after processing the first and second batches.

8. The method of claim 1, wherein the third batch of mail further comprises mail having an address that could not be determined.

9. A two-pass sorting method for sorting a plurality of mail pieces, comprising:
inputting the plurality of mail pieces into a sorting system;
configuring the sorting system to sort the plurality of mail pieces into at least (1) a first batch of mail comprising (a) mail pieces addressed to a first delivery point on a first carrier route and (b) mail pieces addressed to a first delivery point on a second carrier route, and (2) a second batch of mail comprising mail pieces addressed to delivery points that have been placed on hold;
inputting the first batch of mail into the sorting system after inputting all of the plurality of mail pieces into the sorting system;
inputting a batch of saturation mail into the sorting system after inputting all of the plurality of mail pieces into the sorting system;
configuring the sorting system to create, at the least, a third batch of mail consisting of a plurality of mail pieces, each of which is addressed to a delivery point on the same carrier route.

10. A two-pass mail sorting method, comprising:
for the first pass, inputting a batch of mail into a sorting system, wherein the sorting system is configured to create N sub-batches of mail and wherein at least one of the N sub-batches of mail includes mail pieces from the batch that are addressed to a delivery point that has been placed on hold;
for the second pass, inputting into the sorting system all of the N sub-batches of mail except for the sub-batch or sub-batches comprising mail pieces that are addressed to a delivery point that has been placed on hold; and
for the second pass, inputting into the sorting system a batch of saturation mail.
